(19) United States
(12) Patent Application Publication
(10) Pub. No.: US 2009/0018715 A1
(43) Pub. Date: Jan. 15, 2009

(54) CONTROL APPARATUS FOR HYBRID VEHICLE

(75) Inventor: Takeshi KANAYAMA, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/144,218

(22) Filed: Jun. 23, 2008

(30) Foreign Application Priority Data
Jul. 9, 2007 (JP) 2007-180080

(51) Int. Cl. B60W 20/00; B60W 10/18; B60W 10/08

(52) U.S. Cl. 701/22; 477/4; 903/930

(57) ABSTRACT

In one embodiment, a first motor is used upon stopping or starting of an engine during driving of a vehicle. When a stop control or a start control of the engine is executed, a target drive force required to be generated by a second motor is calculated based on a drive force required for driving. A positive drive force required for elimination in a specific rotation direction of backlash occurring in mutual meshing sections of gears of a power distribution mechanism is added to the target drive force. Meanwhile, a braking force required of a brake in order to cancel the added positive drive force so as not to be transmitted to drive wheels is calculated. Based on the results of calculation, coordinated control is executed in which the second motor and the brake are operated in a linked manner.

### CROSS REFERENCE TO RELATED APPLICATIONS

This application claims priority under 35 U.S.C. §119(a) on Japanese Patent Application No. 2007-180080 filed in Japan on Jul. 9, 2007, the entire contents of which are herein incorporated by reference.

### BACKGROUND OF THE INVENTION

1. Field of Invention

The present invention relates to a control apparatus used in a hybrid vehicle having an engine and a motor as a drive source. The hybrid vehicle is equipped with a planetary-gear type power distribution mechanism in order to output drive force generated using the engine, the motor, or both thereof to drive wheels.

2. Related Art

In terms of the conventional technology, hybrid vehicles equipped with, for example, two motor-generators, each of which is capable of being used optionally as a motor or as a generator, have been proposed (see, for example, JP 2005-212494A, Japanese Patent No. 3585121, and JP 2005-232993A).

Within the hybrid vehicle, a first motor-generator, a power distribution mechanism, a second motor-generator, and a reduction mechanism (or gear-shift mechanism) are provided in a motive power transmission path extending from an engine to drive wheels.

With a hybrid vehicle so configured, it is possible to optionally select an engine drive mode, an electric vehicle mode, or a hybrid mode.

In the engine drive mode, the engine alone drives the hybrid vehicle. In the electric vehicle mode, the second motor-generator alone operates as a motor and drives the hybrid vehicle. In the hybrid mode, both the engine and the second motor-generator drive the hybrid vehicle.

A planetary gear mechanism of an appropriate type is, for example, used as the power distribution mechanism and the reduction mechanism provided in a hybrid vehicle of this type.

It should be noted that, the first motor-generator is, for example, used as a generator receiving drive force from the engine via the power distribution mechanism and supplying electrical power to the second motor-generator, and in addition, is used as a motor when starting the engine by cranking thereof. Meanwhile, the second motor-generator is controlled so as to realize a power running mode wherein a positive drive force is applied to an output shaft and a regenerative mode wherein a negative drive force is applied to the output shaft.

In the above-mentioned conventional technology, the power distribution mechanism disposed between the first motor-generator and the second motor-generator comprises a planetary gear mechanism, and, in order, for example, to maintain operational smoothness in such a planetary-gear type power distribution mechanism, an appropriate amount of backlash generally needs to be provided in meshing sections between gears (i.e., a sun gear, a ring gear, and a pinion gear).

As the existence of backlash in the planetary-gear type power distribution mechanism is therefore unavoidable, rattling noise may be emitted from the planetary gear mechanism in, for example, a condition wherein the engine is stopped or started, etc. during driving of the vehicle in the hybrid mode.

That is to say, a phenomenon wherein a meshing position of each of the gears (i.e., the sun gear, the ring gear, and the pinion gear) reverses (that is, backlash reversal) of the power distribution mechanism may occur upon starting or stopping, etc. of the engine during driving of the vehicle in the hybrid mode, and the reversal of the meshing position is believed to generate a rattling noise.

It should be noted that, although any rattling noise generated in a case where, for example, background noise is loud will not be conspicuous, rattling noise generated when background noise is quiet is concerned to be conspicuous. Accordingly, room for improvement can be said to exist in cases where thorough silence is required.

It should be noted that, although a purpose of the conventional technology according to the above-mentioned Japanese Patent No. 3585121 and JP 2005-232993A is identified as being suppression or prevention of occurrence of rattling noise by eliminating looseness (corresponding to backlash) in the power distribution mechanism, there is no disclosure therein of a technical concept of coordinating drive force control using a second motor and braking force control using a vehicle brake as disclosed herein.

### SUMMARY OF THE INVENTION

It is an object of the present invention to provide a control apparatus for a hybrid vehicle capable of suppressing or preventing occurrence of rattling noise caused by backlash in a planetary-gear type power distribution mechanism.

The present invention is a control apparatus for a hybrid vehicle comprising a first motor for cranking of the engine at least upon starting thereof and a planetary-gear type power distribution mechanism for output to drive wheels of a drive force generated by the engine, a second motor, or both thereof, and in addition to an engine stop control and an engine start control, performing a coordinated control in a linked manner upon execution of the engine stop control or the engine start control.

The engine stop control applies a negative drive force generated by the first motor to the engine upon stopping thereof during driving of the vehicle.

The engine start control performs cranking by applying a positive drive force generated by the first motor to the engine upon starting thereof during driving of the vehicle.

In the coordinated control, whenever the engine stop control or the engine start control is executed, a target drive force required to be generated by the second motor is calculated based on a drive force required for driving, a positive drive force required to eliminate backlash in a specific rotation direction at mutual meshing sections of the gears of the power distribution mechanism is added to the target drive force, a braking force of a vehicle brake required for cancellation in order to prevent the added positive drive force from being transmitted to the drive wheels is calculated, and the second motor and the vehicle brake are operated in a coordinated manner based on the results of calculation.

It should be noted that, in order to, for example, maintain operational smoothness in a planetary-gear type power distribution mechanism, meshing sections between gears are generally provided with an appropriate amount of backlash.

In a condition, such as starting or stopping of the engine, wherein the mutual meshing positions of gears of the power distribution mechanism can reverse, the coordinated control uses the second motor to eliminate the backlash in a specific rotation direction.

As a result, reversal of the mutual meshing positions of the gears of the power distribution mechanism upon stopping or starting of the engine becomes less likely, and suppression or prevention of the occurrence of rattling noise becomes possible. In addition, as the positive drive force for elimination of the backlash is cancelled using the vehicle brake in the coordinated control, an increase of the vehicle speed against the will of the driver does not occur. These characteristics make it possible for quietness to be improved without impairing the driving performance of the hybrid vehicle.

Furthermore, as two motors are provided in a hybrid vehicle wherein the control apparatus associated with the present invention is employed, upon execution of the engine start control, the engine stop control, or the coordinated control, the control system by the control apparatus associated with the present invention is simplified, which is beneficial in terms of suppressing increase in the cost of designing the control system.

It is preferable that the first motor be disposed between the engine and the power distribution mechanism, that the second motor be disposed closer to a drive force output than the power distribution mechanism, that the power distribution mechanism is a planetary gear mechanism of single planetary type, and that the rotor of the first motor be connected to the sun gear thereof, the crankshaft of the engine be connected to the carrier thereof via the input shaft, and the output shaft be connected to the ring gear thereof In this way, a motive power transmission path, etc. can be clearly defined by specifying individual component parts.

It is preferable that, upon execution of the engine stop control or the engine start control, a presumptive judgment be made first of all regarding whether or not the coordinated control needs to be executed, that if the coordinated control is deemed necessary, the coordinated control be executed in a linked manner with the engine stop control or the engine start control, and if the coordinated control is deemed unnecessary, the coordinated control be not executed and only the engine stop control or the engine start control be executed.

According to this configuration, the coordinated control can be executed only when needed upon execution of the engine stop control or the engine start control, and therefore, wasteful practice can be avoided, etc., and over-complication of control can be prevented.

It is preferable that, upon execution of the coordinated control, an investigation be performed to determine whether or not the vehicle brake is abnormal, and that if normal, the coordinated control be executed in a linked manner with the engine stop control or the engine start control, and if abnormal, either the engine stop control or the engine start control be prohibited and the coordinated control be prohibited.

According to this configuration, the coordinated control is performed upon execution of the engine stop control or the engine start control only when the vehicle brake required for the coordinated control is confirmed to be normal, and therefore, reliability in terms of normal linking of the coordinated control with the engine stop control or the engine start control is improved.

It is preferable that, after the coordinated control has been executed and prior to execution of the engine stop control or the engine start control to be linked therewith, if execution of the other of the engine stop control or the engine start control is required, the coordinated control be ended without executing the control to be linked, and the required control be then executed.

With this configuration, the coordinated control can be cancelled even during execution thereof in order to give priority to a request of the driver. Accordingly, driving performance in accordance with the wishes of the driver can be maintained.

According to the hybrid vehicle control apparatus associated with the present invention, occurrence of rattling noise caused by backlash in a planetary-gear type power distribution mechanism of the hybrid vehicle can be suppressed or prevented. Accordingly, the present invention is beneficial in terms of improving the quietness of hybrid vehicles.

### BRIEF DESCRIPTION OF THE DRAWINGS

FIG. 1 is a view showing a schematic configuration of a hybrid vehicle whereto the present invention is applied.

FIG. 2 is a view showing a schematic representation of a gear train of the hybrid vehicle of FIG. 1.

FIG. 3 is a flowchart used in an explanation of an operation upon stopping of the engine in an embodiment of a hybrid vehicle control apparatus associated with the present invention.

FIGS. 4(a) to 4(f) are timing charts used in an explanation of an operation of various sections upon stopping of the engine of FIG. 3.

FIG. 5 is a collinear view of a power distribution mechanism upon stopping of the engine of FIG. 3.

FIG. 6 is a view showing a schematic representation of the power distribution mechanism of FIG. 1 as seen from a first motor-generator and showing a rotation direction of each gear during coordinated control linked with stopping of the engine.

FIG. 7 is a view showing a schematic representation of the power distribution mechanism of FIG. 1 as seen from the first motor-generator and showing the rotation direction of each gear upon stopping of the engine.

FIG. 8 is a flowchart used in an explanation of an operation upon starting of the engine in an embodiment of a hybrid vehicle control apparatus associated with the present invention.

FIGS. 9(a) to 9(g) are timing charts used in an explanation of an operation of various sections upon starting of the engine of FIG. 8.

FIG. 10 is a collinear view of the power distribution mechanism upon starting of the engine of FIG. 8.

FIG. 11 is a view showing a schematic representation of the power distribution mechanism of FIG. 1 as seen from the first motor-generator and showing the rotation direction of each gear during coordinated control linked with starting of the engine.

FIG. 12 is a view showing a schematic representation of the power distribution mechanism of FIG. 1 as seen from the first motor-generator and showing the rotation direction of each gear upon starting of the engine.

### DESCRIPTION OF THE PREFERRED EMBODIMENTS

The following is a detailed description of embodiments of the present invention, with reference to the accompanying drawings.

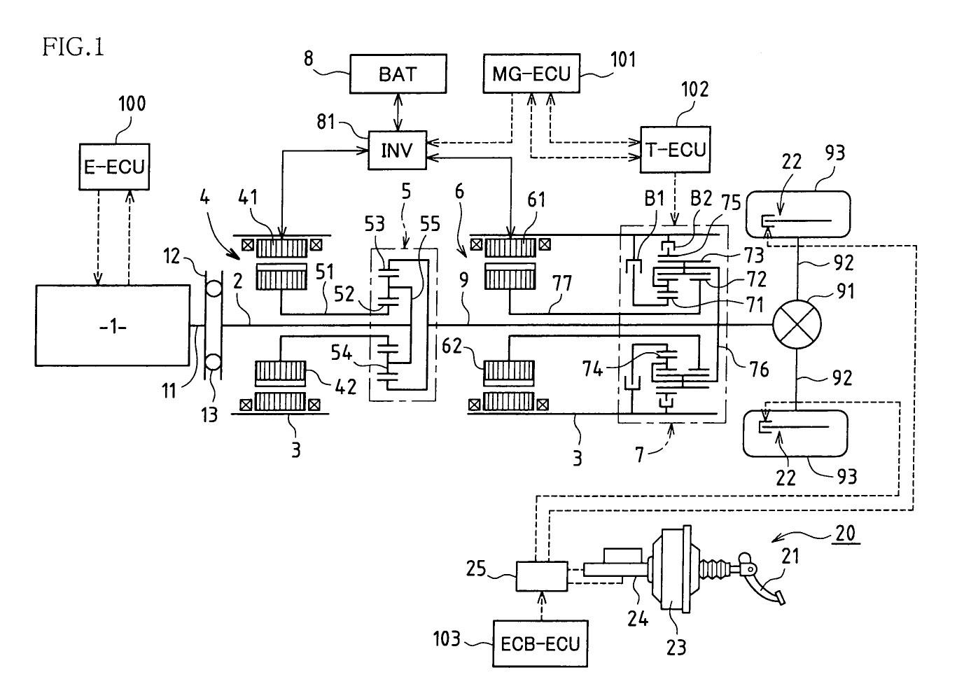

FIGS. 1 to 12 show an embodiment of the present invention. A hybrid vehicle of a front-engine, rear-drive (FR) type is presented as an example for the purpose of this embodiment.

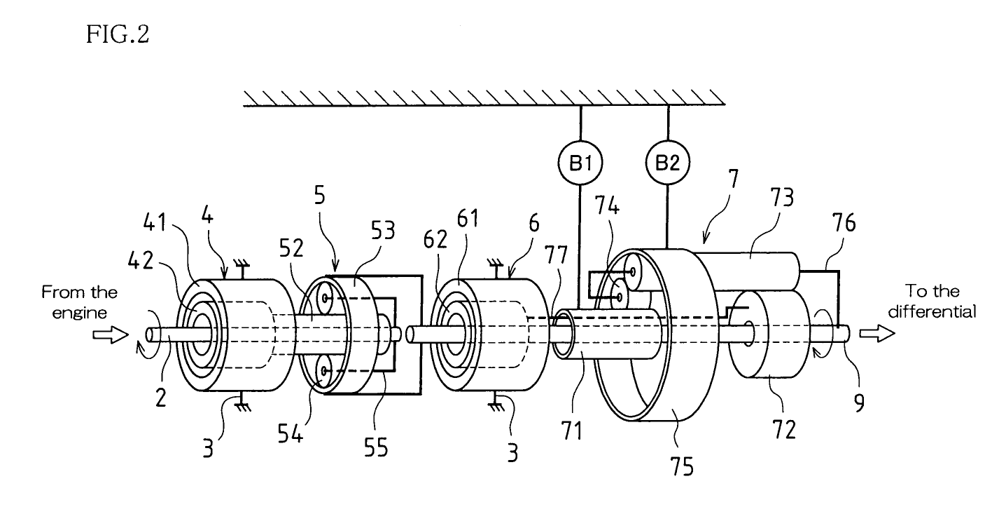

Hereinafter, prior to explaining sections wherein characteristic features of the present invention is applied, an outline summary of a hybrid vehicle whereto the present invention is applied is explained with reference to FIGS. 1 and 2. FIG. 1 is a view showing a schematic configuration of the hybrid vehicle, and FIG. 2 is a view showing a schematic representation of a gear train of the hybrid vehicle.

The hybrid vehicle shown therein principally comprises an engine 1, a first motor-generator 4 (MG1) functioning principally as a generator, a power distribution mechanism 5, a second motor-generator 6 (MG2) functioning principally as a motor, and a reduction mechanism 7.

The first motor-generator 4, the power distribution mechanism 5, the second motor-generator 6, and the reduction mechanism 7 are disposed in the sequence of listing within a motive power transmission path extending from the engine 1 to drive wheels 93 and are housed inside a casing 3.

It should be noted that the first motor-generator 4 corresponds to the first motor recited in the claims and that the second motor-generator 6 corresponds to the second motor recited in the claims.

A basic configuration and operation of each of the aforementioned elements (4 to 7) of the hybrid vehicle are well known, and therefore, sections related to the characteristic features of the present invention are explained in detail, and sections unrelated to the characteristic features of the present invention are explained in brief.

Any gasoline engine, diesel engine, or LPG engine, etc. burning a fuel-air mixture comprising fuel and air within a chamber, converting thermal energy thereof into rotational kinetic energy, and outputting the same can be applied as the engine 1. An operation of the engine 1 is controlled by an E-ECU 100.

A crankshaft 11 constituting an output shaft of the engine 1 is disposed in a longitudinal direction of the vehicle, and a flywheel 12 is provided at a rear end of the crankshaft 11. An input shaft 2 is connected to the flywheel 12 via a damper mechanism 13. The crankshaft 11 and the input shaft 2 are disposed on a single straight line, or in other words, are coaxial. The input shaft 2 is passed through a rotor 42 of the first motor-generator 4 (explained hereinafter) so as to be capable of relative rotation therein.

A synchronous motor provided both with power running functionality for conversion of electrical energy into kinetic energy and with regenerative functionality for conversion of kinetic energy into electrical energy is used as the first motor-generator 4 and the second motor-generator 6.

In specific terms, the first motor-generator 4 receives drive force of the engine 1 via the power distribution mechanism 5 and generates electricity in order to provide the same to the second motor-generator 6, and in addition, functions as a source of drive force upon starting and stopping of the engine 1 or moving off of the vehicle, etc. Meanwhile, the second motor-generator 6 operates in an auxiliary role as a source of drive force for the vehicle, and in addition, functions as a generator of electricity through regenerative action upon braking and deceleration.

The first motor-generator 4 comprises a stator 41 and a rotor 42, and the second motor-generator 6 comprises a stator 61 and a rotor 62. Furthermore, each of the first motor-generator 4 and the second motor-generator 6 is configured such that control of the power running functionality and regenerative functionality as well as of the drive force corresponding to each thereof is achieved by controlling an inverter 81 using an MG-ECU 101. The stators 41, 61 are fixed to an inner wall of the casing 3.

In addition, the first motor-generator 4 and the second motor-generator 6 are connected via the inverter 81 to a power storage apparatus 8 capable of receiving and supplying electrical power.

The power distribution mechanism 5 comprises a single-pinion-type planetary gear mechanism and principally contains a sun gear 52, a ring gear 53, a plurality of pinion gears 54, and a carrier 55.

The sun gear 52 is formed as one with a hollow shaft 51, and the hollow shaft 51 is connected to the rotor 42 of the first motor-generator 4 so as to be capable of rotating in unison therewith.

The ring gear 53 is disposed outside, and is concentric with, the sun gear 52 and is connected to an output shaft 9 so as to be capable of rotating in unison therewith.

The plurality of pinion gears 54 are disposed between the sun gear 52 and the ring gear 53 so as to mesh therewith.

The carrier 55 holds the plurality of pinion gears 54 in a circumferentially equidistant configuration and supports the same so as to be capable of rotating freely, and in addition, is connected to the input shaft 2 so as to be capable of rotating in unison therewith. The input shaft 2 is inserted into the hollow shaft 51 so as to be capable of relative rotation.

The reduction mechanism 7 comprises a Ravigneaux-type planetary gear mechanism and principally contains a front sun gear 71, a rear sun gear 72 having a larger diameter than the front sun gear 71, a long pinion gear 73, a short pinion gear 74, a ring gear 75, and a carrier 76.

The front sun gear 71 is connected to a first brake B1 permitting or restricting rotation of the front sun gear 71. The first brake B1 is, for example, a hydraulic-control-type frictional engagement apparatus.

The rear sun gear 72 is connected via a hollow shaft 77 to the rotor 62 of the second motor-generator 6 so as to rotate in unison therewith.

The long pinion gear 73 meshes with the front sun gear 71 via the short pinion gear 74. That is to say, the short pinion gear 74 meshes with both the long pinion gear 73 and the front sun gear 71. Furthermore, the long pinion gear 73 meshes with both the rear sun gear 72 and the ring gear 75.

The ring gear 75 meshes with the long pinion gear 73 at an inner circumference thereof, and in addition, is connected to a second brake B2 permitting or restricting rotation of the ring gear 75. The second brake B2 is, for example, a hydraulic-control-type frictional engagement apparatus.

The carrier 76 holds a plurality of long pinion gears 73 and a plurality of short pinion gears 74 in a circumferentially equidistant configuration and supports the same so as to be capable of rotating freely, and in addition, the output shaft 9 is connected to the carrier 76 so as to be capable of rotating in unison therewith.

The output shaft 9 is passed through the hollow shaft 77 so as to be capable of relative rotation therein and is disposed coaxially with the input shaft 2. Furthermore, a front end of the output shaft 9 (i.e., an upstream side in terms of a direction of motive power transmission) is connected to the ring gear 53 of the power distribution mechanism 5 so as to rotate in unison therewith. The hollow shaft 77 is connected to the rotor 62 of the second motor-generator 6 so as to be capable of rotating in unison therewith.

It should be noted that, within the reduction mechanism 7, the rear sun gear 72 constitutes an input element and the carrier 76 constitutes an output element.

Furthermore, the gear train is configured such that a high-speed stage having a gear ratio greater than “1” is set by engaging the first brake B1, and a low-speed stage having a larger gear ratio than the high-speed stage is set by engaging the second brake B2 in place of the first brake B1.

Changing between the respective shift stages is executed based on a travel condition such as a vehicle speed or a required drive force (or an accelerator opening degree). More specifically, a gear-stage region is set in advance in the form of a map (i.e., a gear-shift diagram), and control is performed by a T-ECU 102 so as to set one of the gear stages in accordance with a driving condition.

Meanwhile, the output shaft 9 is connected to a differential 91 via a propeller shaft (not shown), and a pair of drive wheels 93 is mounted on the differential 91 via a pair of left and right drive shafts 92.

A vehicle brake 20 (hereinafter, referred to simply as a “brake”) is provided on each of the drive wheels 93. The brake 20 comprises, for example, an electronically controlled brake (ECB) system, having a brake mechanism section 22, a booster 23, a master cylinder 24, and a brake actuator 25, etc.

The brake mechanism section 22 is a disk brake comprising a disk rotor (reference numeral omitted) and a brake pad (reference numeral omitted). However, although not shown in the figures, the brake mechanism section 22 may be a drum brake comprising a brake shoe and a brake drum.

An operation of the brake 20 is such that, when a driver performs a by-foot depression operation of a brake pedal 21 disposed inside the vehicle's passenger compartment, a corresponding operation force (or depression force) is converted into a brake fluid pressure by the master cylinder 24, and the brake fluid pressure is applied to the brake mechanism section 22 so as to perform a braking operation on the drive wheels 93; in addition, in order to perform a known brake assist control and a known antilock brake control, etc., a braking force of the drive wheels 93 can be controlled by an ECB-ECU 103, for example, based on driving information such as the depression force or vehicle speed, etc. through adjustment of the brake fluid pressure applied from the brake actuator 25 to the brake mechanism section 22.

It should be noted that, as generally known, each of the above-described ECUs 100, 101, 102, 103 comprises a CPU, ROM, RAM, and backup RAM, etc., and two way exchange of necessary information can be carried out therebetween. Various control programs and maps, etc. referenced upon the execution thereof are stored in the ROM. The CPU performs various arithmetic processes based on the various control programs and maps, etc. stored in the ROM. Furthermore, the RAM constitutes memory for temporary storage of results of arithmetic processing by the CPU and data input from sensors, etc., and the backup RAM is non-volatile memory for storage of data, etc. that is to be saved when, for example, the engine 1 is stopped.

Hereinafter, an operation of the power distribution mechanism 5 is explained.

When a reaction drive force of the first motor-generator 4 with respect to a drive force of the engine 1 input into the carrier 55 is input into the sun gear 52, a drive force larger than the drive force input from the engine 1 can be output from the ring gear 53.

In such a case, the first motor-generator 4 functions as a generator. Furthermore, if a revolution number (i.e., output revolution number) of the ring gear 53 is kept constant, a revolution number of the engine 1 can be changed in a continuous (i.e., stepless) fashion by increasing and decreasing a revolution number of the first motor-generator 4. By controlling the first motor-generator 4, therefore, the revolution number of the engine 1 can be controlled so as to, for example, achieve optimum fuel efficiency.

Hereinafter, an operation of the reduction mechanism 7 is explained.

If the ring gear 75 is secured by the second brake B2, a low-speed stage “L” is set, and drive force output by the second motor-generator 6 is increased in accordance with a gear ratio and applied to the output shaft 9.

In contrast, if the front sun gear 71 is secured by the first brake B1, a high-speed stage “H” having a smaller gear ratio than the low-speed stage “L” is set.

As the gear ratio corresponding to the high-speed stage “H” is also greater than “1”, the drive force output by the second motor-generator 6 is increased in accordance with the gear ratio and applied to the output shaft 9.

It should be noted that when the low-speed stage “L” or the high-speed stage “H” is set in a steady condition, the drive force applied to the output shaft 9 is the output drive force of the second motor-generator 6 increased in accordance with the gear ratio; however, when the gear ratio is transient, the drive force applied to the output shaft 9 is affected by factors such as a drive force capacity of each of the brakes B1, B2 and inertial drive force pursuant to a change of revolution number.

Furthermore, the drive force applied to the output shaft 9 is a positive drive force in driving status of the second motor-generator 6 and a negative drive force in driven status.

The above-explained hybrid vehicle simultaneously reduces a volume of exhaust gas and improves fuel efficiency by operating the engine 1 as efficiently as possible, and in addition, performs energy regeneration in order to further improve fuel efficiency.

Accordingly, in a case wherein a large drive force is required, the second motor-generator 6 is driven while the drive force of the engine 1 is being transmitted to the output shaft 9, and the drive force of the second motor-generator 6 is applied to the output shaft 9.

In such case, when the vehicle speed is low, the reduction mechanism 7 is set to the low-speed stage “L” so as to increase the applied drive force, and if the vehicle speed subsequently increases, the reduction mechanism 7 is set to the high-speed stage “H” and the revolution number of the second motor-generator 6 is reduced. This operation is performed in order to maintain the drive efficiency of the second motor-generator 6 in a favorable state so as to prevent deterioration of the fuel efficiency.

Accordingly, a gear-shift operation may be performed using the reduction mechanism 7 during driving of this hybrid vehicle with the second motor-generator 6 operating.

The gear-shift operation is executed by switching an engagement and disengagement state of each of the above-described brakes B1, B2.

For example, switching from the low-speed stage “L” to the high-speed stage “H” is executed by disengaging the second brake B2 from the engaged state thereof and simultaneously engaging the first brake B1. Furthermore, switching from the high-speed stage “H” to the low-speed stage “L” is executed by disengaging the first brake B1 from the engaged state thereof and simultaneously engaging the second brake B2.

It should be noted that, with the above-explained hybrid vehicle, an engine drive mode, an electric vehicle (EV) mode, or a hybrid mode can be optionally selected.

Engine Drive Mode

In the engine drive mode, a fuel is supplied to the engine 1 such that the engine 1 rotates autonomically, and in addition, supply of electrical power to the second motor-generator 6 is stopped.

When the engine 1 is rotating autonomically, an engine drive force is transmitted to the output shaft 9 via the input shaft 2, the carrier 55, and the ring gear 53. A drive force of the output shaft 9 is transmitted to the pair of drive wheels 93 via the propeller shaft, the differential 91, and the pair of drive shafts 92.

Electric Vehicle Mode

In the electric vehicle mode, the second motor-generator 6 is operated as an electric motor, and a drive force of the second motor-generator 6 is transmitted to the pair of drive wheels 93 via the reduction mechanism 7, the output shaft 9, the differential 91, and the pair of drive shafts 92. Fuel is not supplied to the engine 1 in the electric vehicle mode.

Hybrid Mode

In the hybrid mode, the engine 1 rotates autonomically and electrical power is supplied to the second motor-generator 6, and both the drive force of the engine 1 and the drive force of the second motor-generator 6 are transmitted to the pair of drive wheels 93.

In this way, the vehicle can mechanically distribute drive force generated using the engine 1 to the pair of drive wheels 93 and to the first motor-generator 4 via the power distribution mechanism 5, and in addition, can use the engine 1, the second motor-generator 6, or both thereof as a drive source.

Furthermore, if a revolution speed of the first motor-generator 4 is controlled using a differential function of the sun gear 52, the carrier 55, and the ring gear 53 of the power distribution mechanism 5 while the engine drive force is being transmitted to the power distribution mechanism 5, the revolution number of the engine 1 can be controlled in a stepless (i.e., continuous) fashion, and therefore, the power distribution mechanism 5 can function as a continuously variable transmission.

Furthermore, in a case wherein either the above-explained electric vehicle mode or hybrid mode is selected, a gear shift mode explained hereinafter becomes selectable in line with control of the reduction mechanism 7.

Either a low-speed gear shift mode (i.e., low speed mode) or a high-speed gear shift mode (i.e., high speed mode) can be selected based on the vehicle speed and required drive force, etc. The required drive force is determined based on, for example, a signal from an accelerator opening-degree sensor, etc.

For example, the low speed mode is selected when the vehicle speed is equal to or less than a specified speed and the accelerator opening-degree equal to or greater than a specified value, and the high speed mode is selected when the vehicle speed is greater than the specified speed and the accelerator opening-degree is less than the specified value.

When the low speed mode is selected, the first brake B1 is disengaged and the second brake B2 is engaged. When the low speed mode has been selected, and in addition, the drive force of the second motor-generator 6 is transmitted to the rear sun gear 72, the ring gear 75 becomes a reaction element, and the drive force of the rear sun gear 72 is transmitted to the pair of drive wheels 93 via the carrier 76, the output shaft 9, and the differential 91. It should be noted that a revolution speed of the output shaft 9 is slower than a revolution speed of the second motor-generator 6.

The gear ratio of the reduction mechanism 7 becomes “Low” (i.e., maximum gear ratio) when the low speed mode has been selected.

Meanwhile, when the high speed mode is selected, the second brake B2 is disengaged and the first brake B1 is engaged. Furthermore, the second motor-generator 6 is driven as an electric motor, the front sun gear 71 becomes a reaction element, and the drive force of the rear sun gear 72 is transmitted to the pair of drive wheels 93 via the carrier 76, the output shaft 9, and the differential 91. It should be noted that a revolution speed of the output shaft 9 is slower than a revolution speed of the second motor-generator 6.

The gear ratio of the reduction mechanism 7 becomes “High” (i.e., minimum gear ratio) when the high speed mode has been selected, and the corresponding gear ratio is lower than the gear ratio of the above-explained low speed mode.

Furthermore, when the vehicle is running on inertia, the kinetic energy thereof is transmitted from the pair of drive wheels 93 to the second motor-generator 6, and in addition, the electrical power generated in the second motor-generator 6 can be stored in the power storage apparatus 8.

It should be noted that drive force can be obtained when the vehicle is reversing as the second motor-generator 6 rotates in reverse at such time.

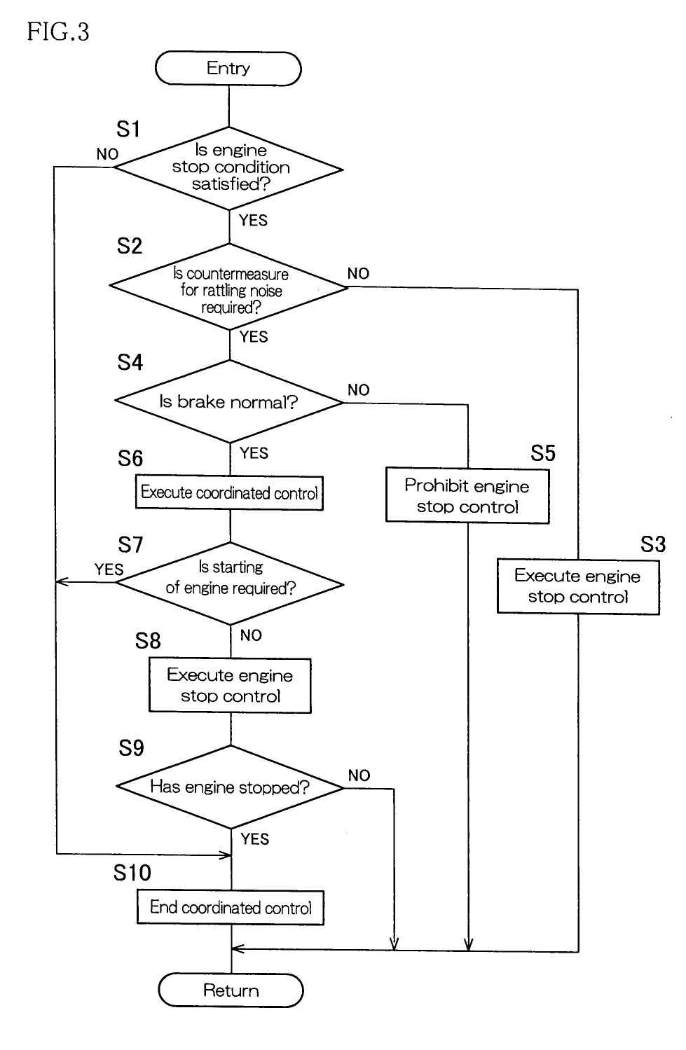

Hereinafter, the characteristic features of the present invention will be explained in detail with reference to FIGS. 3 to 12.

In brief, the present invention has been optimized so as to suppress or prevent occurrence of rattling noise caused by backlash present in meshing sections between the gears (i.e., the sun gear 52, the ring gear 53, and the pinion gears 54) of the planetary-gear type power distribution mechanism 5 provided in a hybrid vehicle.

In this embodiment, particularly in cases wherein rattling noise readily occurs, such as, for example, when a stop control or a start control of the engine 1 is carried out while hybrid vehicle is driving in the hybrid mode, a coordinated control of the second motor-generator 6 and the brake 20 is performed in a linked manner so as to eliminate the above-mentioned backlash in a specific rotation direction and to prevent reversal (i.e., backlash reversal) of mutual meshing positions of the gears (i.e., the sun gear 52, the ring gear 53, and the pinion gears 54).

An operation of an embodiment of the present invention whereto the special features thereof have been applied is hereinafter explained.

A control executed upon stopping of the engine 1 during driving of the vehicle in the hybrid mode is explained first of all with reference to FIG. 3. The flowchart of FIG. 3 principally comprises operations performed by the E-ECU 100, and control enters the flowchart at fixed intervals.

In a step S1, it is determined whether or not an appropriate condition for stopping of the engine 1 has been satisfied during driving of the vehicle in the hybrid mode. When, for example, the degree of accelerator opening reaches 0% or the vicinity thereof due, for example, to the driver releasing an accelerator pedal (not shown), an investigation of whether or not the condition for stopping of the engine 1 has been satisfied may be carried out using data (prepared in advance based on testing) determining a usage ratio of the engine 1 and of the second motor-generator 6 with fuel efficiency and driving performance, etc. taken into consideration.

If the condition for stopping of the engine is not satisfied, a negative judgment is made in step S1 and control exits the flowchart. However, if the condition for stopping of the engine is satisfied, a positive judgment is made in step S1 and control proceeds to a step S2.

In step S2, a likelihood of occurrence of rattling noise due to backlash of the power distribution mechanism 5 upon stopping of the engine 1 is evaluated, and it is determined whether or not a countermeasure for rattling noise is required. For example, an investigation of whether or not occurrence of the above-explained backlash reversal is probable, or in other words, whether or not occurrence of rattling noise is probable, may be carried out by comparing a current vehicle speed, a target drive force required by the vehicle at a 0% degree of accelerator opening, and a drive force generated by the second motor-generator 6 with data prepared in advance based on testing.

If a countermeasure for rattling noise is not required, a negative judgment is made in step S2, and after performing an engine stop control of a step S3, control exits the flowchart. The engine stop control is explained in detail hereinafter.

Meanwhile, if a countermeasure for rattling noise is required, a positive judgment is made in step S2, and control proceeds to a step S4, wherein it is determined whether or not the brake 20 is abnormal. The determination regarding abnormality of the brake 20 may, for example, be carried out by investigating whether a brake failure flag is “1” or “0” through two-way communication with the ECB-ECU 103.

It should be noted that, the ECB-ECU 103 is configured so as to set the brake failure flag to “1” or “0” upon each operation of the brake pedal 21 in accordance with a result of investigation of whether or not the brake 20 is operating normally based on, for example, an output value of a pressure sensor (not shown) fitted to the master cylinder 24 or a change between a vehicle speed upon the braking operation and a vehicle speed thereafter, etc.

If the brake 20 is abnormal, a negative judgment is made in step S4, and after prohibiting the engine stop control in a step S5, control exits the flowchart.

Meanwhile, if the brake 20 is normal, a positive judgment is made in step S4, and control proceeds to a step S6, wherein the coordinated control of the second motor-generator 6 and the brake 20 is executed.

The E-ECU 100 performs the coordinated control through two-way communication with the MG-ECU 101 and the ECB-ECU 103, thereby controlling the second motor-generator 6 using the MG-ECU 101 and controlling the brake 20 using the ECB-ECU 103. The coordinated control is explained in detail hereinafter.

Next, it is determined in a step S7 whether or not starting of the engine 1 is required. In brief, an investigation of whether or not the driver has performed a by-foot depression operation of the accelerator pedal (not shown) is carried out.

If starting is not required, a negative judgment is made in step S7, the engine stop control is executed in a step S8, and control proceeds to a step S9.

However, if starting is required, a positive judgment is made in step S7 and control proceeds to a step S10, bypassing step S8 and step S9; furthermore, the coordinated control is ended in step S10 and control then exits the flowchart. After proceeding from step S7 to step S10 in this way, control proceeds to an acceleration control routine (not shown) corresponding to the by-foot depression operation of the accelerator pedal.

In step S9, it is determined whether or not the engine 1 has stopped. Specifically, this determination is made by investigating whether or not the engine revolution number has become zero.

If the engine 1 has stopped, a positive judgment is made in step S9, and after stopping the coordinated control in step S10, control exits the flowchart.

However, if the engine 1 has not yet stopped, a negative judgment is made in step S9, and control exits the flowchart without executing step S10.

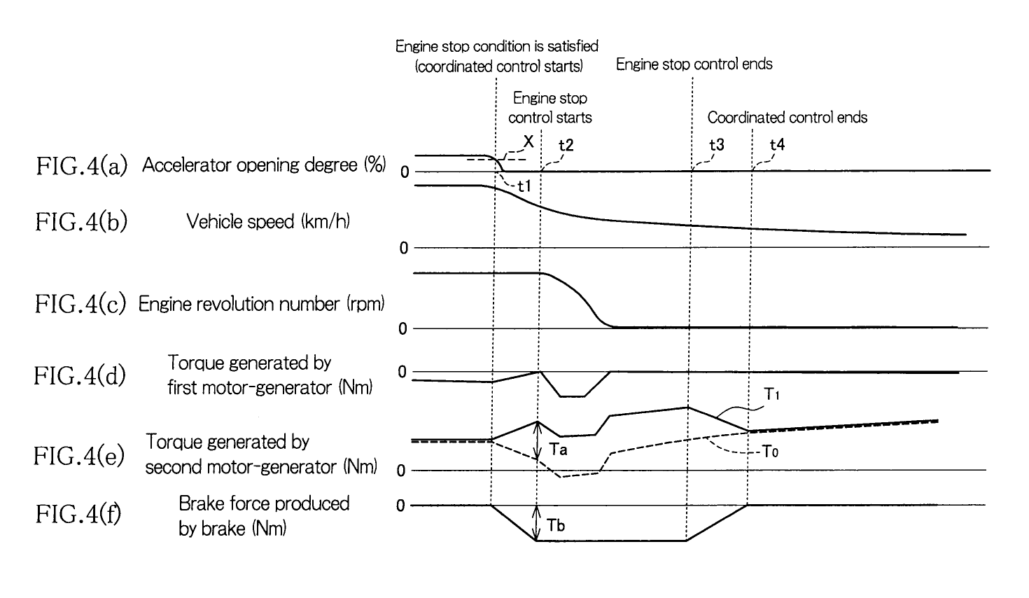

Hereinafter, an operation of each section upon satisfaction of the stop condition of the engine 1 during driving of the vehicle in the hybrid mode is explained, with reference to the timing charts of FIGS. 4(a) to 4(f). For the purposes of this explanation, it is assumed that a countermeasure for rattling noise is required and that the brake 20 is normal.

That is to say, when the degree of accelerator opening drops to or below a threshold X in the vicinity of 0% as a result of, for example, the driver releasing the accelerator pedal, it is determined at a time t1 of FIG. 4(a) that stopping of the engine is required, and the coordinated control is executed. It should be noted that, pursuant to the dropping of the degree of accelerator opening, the vehicle speed begins to gradually decrease at time t1 as shown in FIG. 4(b).

In the coordinated control, first of all, a target drive force T₀ (shown by a dashed line in FIG. 4(e)) required to be generated by the second motor-generator 6 is calculated based on a drive force required for driving, and an actual target drive force T₁ (shown by a solid line in FIG. 4(e)) is calculated by adding to the target drive force T₀ a positive drive force Ta (shown in FIG. 4(e)) required to eliminate backlash in a specific rotation direction at mutual meshing sections of the gears (i.e., the sun gear 52, the ring gear 53, and the pinion gears 54) of the planetary-gear type power distribution mechanism 5; meanwhile, a braking force Th (shown in FIG. 4(f)) of the brake 20 required for cancellation in order to prevent the added positive drive force Ta from being transmitted to the drive wheels 93 is calculated, and subsequently, the second motor-generator 6 and the brake 20 are operated in a coordinated manner based on the results of calculation.

The braking force Tb of the brake 20 is a negative drive force used to decelerate the drive wheels 93, and therefore, is shown on a negative side in FIG. 4(f).

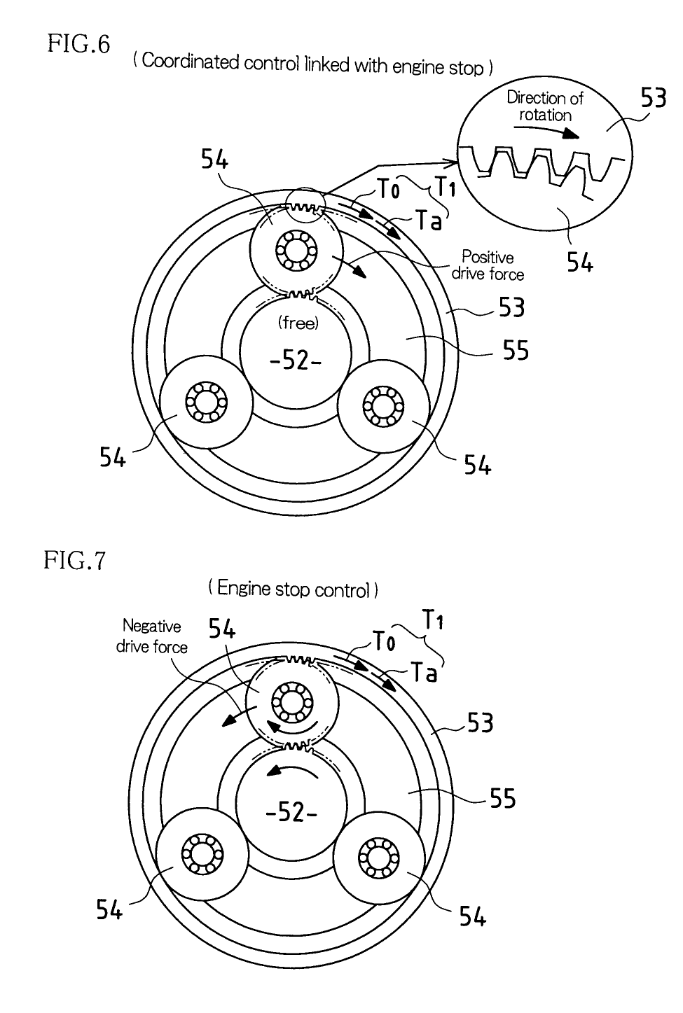

It should be noted that, before the coordinated control, the engine 1 is being driven and the ring gear 53 of the power distribution mechanism 5 is rotating in a direction identical to that of the crankshaft 11, and therefore, when the ring gear 53 is driven by the second motor-generator 6 with the actual target drive force T₁=T₀+Ta as shown by arrows of FIG. 6 pursuant to the coordinated control, the revolution speed of the ring gear 53 becomes faster than that of the carrier 55 driven so as to rotate by the crankshaft 11 of the engine 1 and the pinion gears 54 driven so as to orbit by the carrier 55.

As shown enlarged in FIG. 6, therefore, with the rotation direction of the ring gear 53 as standard, a front surface of an inner tooth of the ring gear 53 with respect to the direction of rotation is in contact with a back surface of an outer tooth of a pinion gear 54 with respect to the direction of rotation, and backlash is eliminated. Such backlash elimination also takes place between the pinion gears 54 and the sun gear 52.

Furthermore, in order to make the backlash elimination gentler, a step-up process is performed at an initial starting stage of the coordinated control in this embodiment.

Specifically, the step-up process comprises gradual increasing of a change in the drive force of the second motor-generator 6 and a change in the braking force of the brake 20 from time t1 to a time t2 as shown in FIGS. 4(e) and 4(f). As a result of execution of the step-up process, execution of the engine stop control is started at time t2.

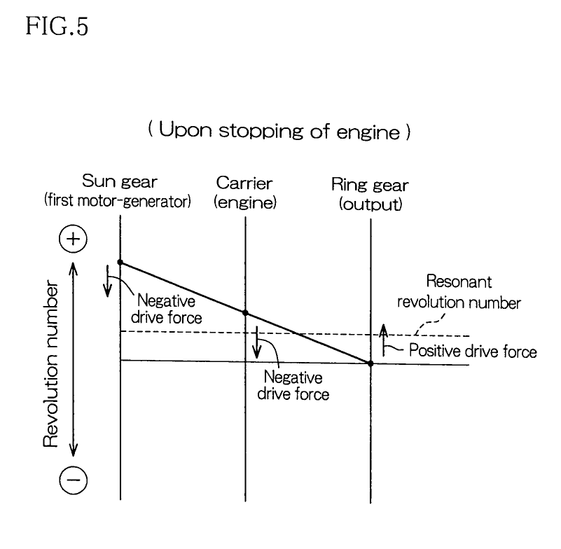

As shown in the collinear view of FIG. 5, in the engine stop control, in addition to stopping fuel supply and ignition, the first motor-generator 4 is operated as an electric motor to drive, as shown in FIG. 4(d) and FIG. 7, the sun gear 52 of the power distribution mechanism 5 so as to rotate in an appropriate direction (i.e., a counter-clockwise direction in the figure), and therefore, a negative drive force in an opposite direction (i.e., a counter-clockwise direction in the figure) is input into the crankshaft 11 of the engine 1 via the pinion gears 54 and the carrier 55. As the negative drive force constitutes a rotation resistance with respect to the crankshaft 11 of the engine 1, the engine revolution number drops in a relatively short period of time as shown in FIG. 4(c).

When, as shown in FIG. 4(c), a time t3 having a specific time lag is reached after the engine revolution number has reached zero as a result of the engine stop control, the engine stop control is ended, or in other words, driving of the first motor-generator 4 is stopped.

Hereinafter, a reason for forcible stopping of the engine stop control as described above is explained.

In order to prevent the occurrence of rattling noise caused by backlash in the power distribution mechanism 5 while the engine 1 is idling, the hybrid vehicle has, in the first place, been tuned such that an engine revolution number whereat the rattling noise occurs readily (i.e., a resonant revolution number) is adjusted to below an idling revolution number. If, for example, forcible stopping of the engine 1 were not to be performed as explained above, there is a danger of a drop rate of the engine revolution number becoming low, a period of transition through the resonant revolution number during an engine stop process becoming delayed, and rattling noise consequently occurring over a relatively long period of time. However, in a case, for example, where forcible stopping of the engine 1 is performed as explained above, the drop rate of the engine revolution number becomes high as shown in the collinear view of FIG. 5, the period of transition through the resonant revolution number during the engine stop process is minimized, and therefore, the period of occurrence of rattling noise can be made as short as possible.

Rattling noise is, however, suppressed or prevented as a result of execution of the above-explained coordinated control. That is to say, although the sun gear 52, the ring gear 53, the pinion gears 54, and the carrier 55 rotate as shown by arrows in FIG. 7 upon stopping of the engine, backlash of the power distribution mechanism 5 is eliminated in a specific rotation direction as shown in FIG. 6 by executing the coordinated control in a linked manner with the engine stop control during a period from before stopping of the engine 1 until after stopping thereof, and therefore, reversal of the position of each of the sun gear 52, the ring gear 53, and the pinion gears 54 becomes impossible and the occurrence of rattling noise can be suppressed or prevented.

Furthermore, the reason for providing a time lag before stopping the engine stop control after the engine revolution number has reached zero as a result thereof is that, in order to prevent reverse rotation of the crankshaft 11 by an engine-stop inertial force pursuant to application of the negative drive force to the engine 1, a process (not shown) whereby an appropriate positive drive force is applied to the engine 1 immediately before the engine revolution number reaches zero is carried out.

Furthermore, a step-down process of the coordinated control is executed in order to maintain backlash elimination from a time (i.e., time t3) at which the engine stop control is ended, and the coordinated control is ended when a time t4 is reached.

Specifically, the step-down process comprises gradual decreasing of a change in the drive force of the second motor-generator 6 and a change in the braking force of the brake 20 from time t3 to time t4 as shown in FIGS. 4(a) to 4(f).

As explained above, when stop control of the engine 1 is performed during driving in the hybrid mode, the coordinated control is performed in a linked manner therewith so as to eliminate the backlash of the power distribution mechanism 5 in a specific rotation direction using the second motor-generator 6. As a result, reversal of the mutual meshing positions of the gears (i.e., the sun gear 52, the ring gear 53, and the pinion gears 54) of the power distribution mechanism 5 becomes less likely, and suppression or prevention of the occurrence of rattling noise becomes possible.

In addition, as the positive drive force Ta for elimination of the backlash is cancelled using the brake 20, an increase of the vehicle speed against the will of the driver does not occur. The above-explained characteristics are beneficial in terms of improving quietness without impairing the driving performance of the hybrid vehicle.

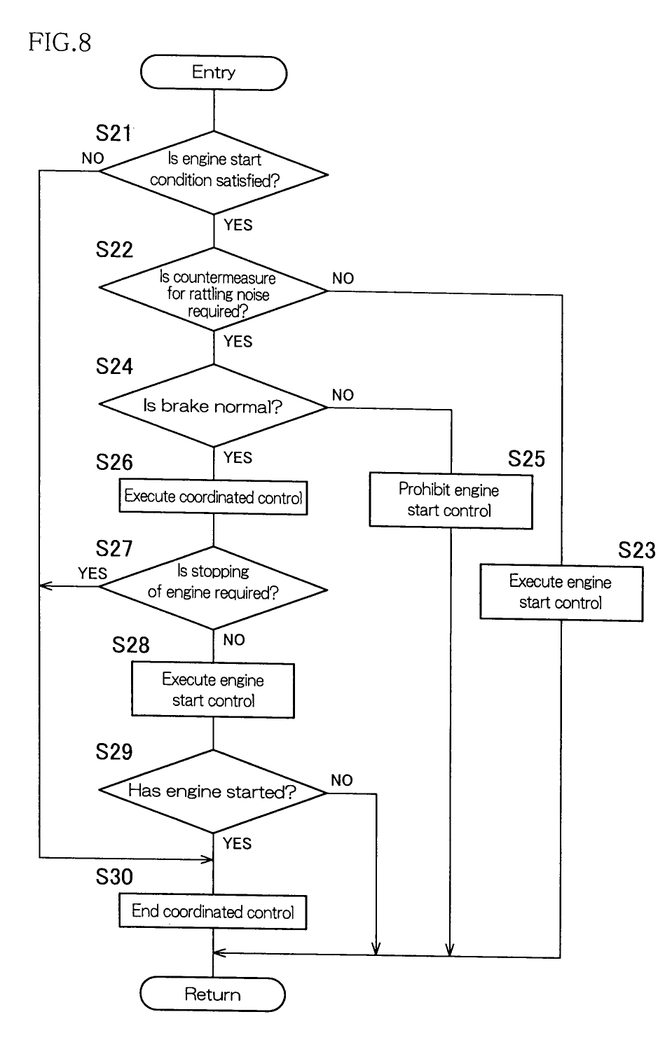

Hereinafter, a control executed upon starting of the engine 1 during driving of the vehicle in the hybrid mode is explained, with reference to the flowchart of FIG. 8. The flowchart of FIG. 8 principally comprises operations performed by the E-ECU 100, and control enters the flowchart at fixed intervals.

In a step S21, it is determined whether starting of the engine 1 is required during driving of the vehicle. In brief, an investigation is carried out in order to determine whether or not charging of the power storage apparatus 8 using the engine 1 is necessary.

If starting is not required, a negative judgment is made in step S21, and control exits this flowchart. Alternatively, if starting is required, a positive judgment is made in step S21 and control proceeds to a step S22.

In step S22, a likelihood of occurrence of rattling noise due to backlash of the power distribution mechanism 5 upon starting of the engine 1 is evaluated, and it is determined whether or not a countermeasure for rattling noise is required. For example, an investigation of whether or not occurrence of the above-explained backlash reversal is probable, or in other words, whether or not occurrence of rattling noise is probable, may be carried out by comparing a current vehicle speed, a target drive force required by the vehicle at a 0% degree of accelerator opening, and a drive force generated by the second motor-generator 6 with data prepared in advance based on testing.

If a countermeasure for rattling noise is not required, a negative judgment is made in step S22, and after performing an engine start control of a step S23, control exits this flowchart. The engine start control is explained in detail hereinafter.

Meanwhile, if a countermeasure for rattling noise is required, a positive judgment is made in step S22, and control proceeds to a step S24, wherein it is determined whether or not the brake 20 is abnormal. The determination regarding abnormality of the brake 20 may, for example, be carried out by investigating whether a brake failure flag is “1” or “0” through two-way communication with the ECB-ECU 103.

It should be noted that, the ECB-ECU 103 is configured so as to set the brake failure flag to “1” or “0” upon each operation of the brake pedal 21 in accordance with a result of investigation of whether or not the brake 20 is operating normally based on, for example, an output value of a pressure sensor (not shown) fitted to the master cylinder 24 or a change between a vehicle speed upon the braking operation and a vehicle speed thereafter, etc.

If the brake 20 is abnormal, a negative judgment is made in step S24, and after prohibiting the engine start control in a step S25, control exits this flowchart.

However, if the brake 20 is normal, a positive judgment is made in step S24, and control proceeds to a step S26, wherein the coordinated control of the second motor-generator 6 and the brake 20 is executed.

The E-ECU 100 performs the coordinated control through two-way communication with the MG-ECU 101 and the ECB-ECU 103, thereby controlling the second motor-generator 6 using the MG-ECU 101 and controlling the brake 20 using the ECB-ECU 103. The coordinated control is explained in detail hereinafter.

Next, it is determined in a step S27 whether or not stopping of the engine 1 is required. In brief, an investigation of whether or not the driver has performed a by-foot depression operation of the brake pedal 21 is carried out.

If stopping is not required, a negative judgment is made in step S27, the engine start control is executed in a step S28, and control proceeds to a step S29.

However, if stopping is required, a positive judgment is made in step S27 and control proceeds to a step S30, bypassing step S28 and step S29; furthermore, the coordinated control is ended in step S30 and control then exits this flowchart.

In step S29, it is determined whether or not the engine 1 has started. Specifically, this determination is made by investigating whether or not the engine 1 has adopted a state wherein independent rotation is possible.

If the engine 1 has started, a positive judgment is made in step S29, and after stopping the coordinated control in step S30, control exits the flowchart.

However, if the engine 1 has not yet started, a negative judgment is made in step S29, and control exits the flowchart without executing step S30.

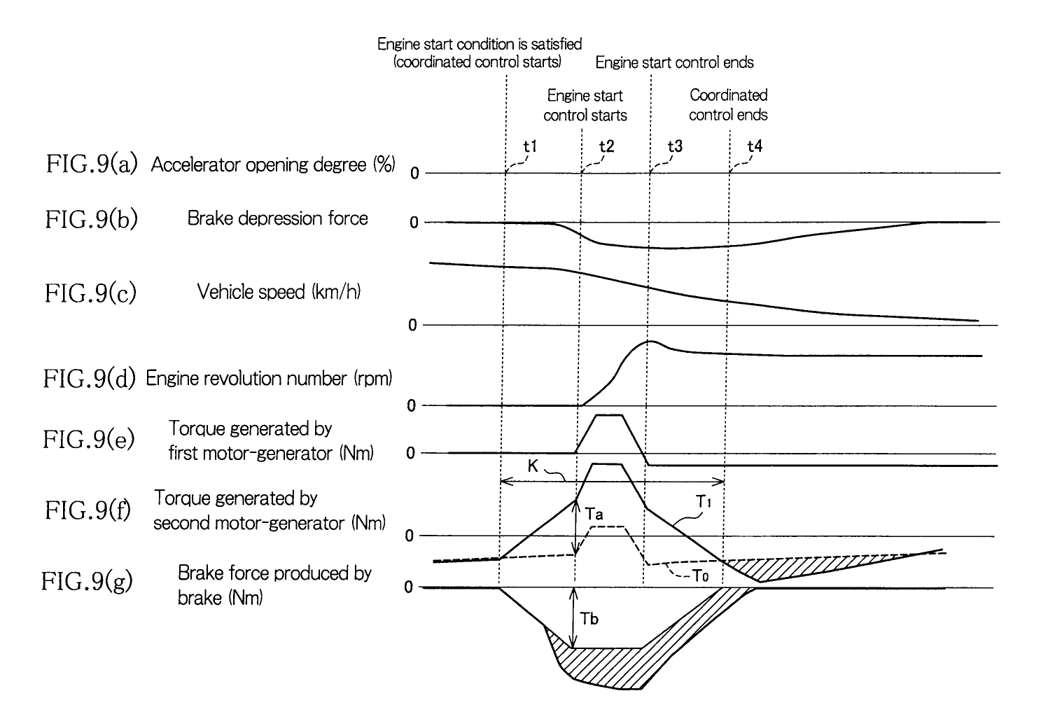

Hereinafter, an operation of each section upon receipt of a start request of the engine 1 during driving of the vehicle in the hybrid mode is explained, with reference to the timing charts of FIGS. 9(a) to 9(g). For the purposes of this explanation, it is assumed that a countermeasure for rattling noise is required and that the brake 20 is normal.

FIGS. 9(a) to 9(g) correspond to an example wherein the engine 1 is started due to a requirement for charging of the power storage apparatus 8 and not due to the driver performing a by-foot depression operation of the accelerator pedal.

That is to say, as shown in FIG. 9(a), the degree of accelerator opening is 0% prior to receipt of the engine start request, and as shown in FIG. 9(f), regenerative control is carried out with the second motor-generator 6 operating as a generator. However, regenerative control is prohibited during a period K extending from the start (at a time t1) of the coordinated control explained hereinafter to the end thereof (at a time t4).

Coordinated control is executed upon the receipt of a start request at time t1 in FIGS. 9(a) to 9(g).

In the coordinated control, first of all, a target drive force T₀ (shown by a dashed line in FIG. 9(f) required to be generated by the second motor-generator 6 based on a drive force required for driving is calculated, and an actual target drive force T₁ (shown by a solid line in FIG. 9(f)) is calculated by adding to the target drive force T₀ a positive drive force Ta (shown in FIG. 9(f)) required to eliminate backlash in a specific rotation direction at mutual meshing sections of the gears (i.e., the sun gear 52, the ring gear 53, and the pinion gears 54) of the planetary-gear type power distribution mechanism 5; meanwhile, a braking force Th (shown in FIG. 9(g)) of the brake 20 required for cancellation in order to prevent the added positive drive force Ta from being transmitted to the drive wheels 93 is calculated, and subsequently, the second motor-generator 6 and the brake 20 are operated in a coordinated manner based on the results of calculation.

The braking force Th of the brake 20 is a negative drive force used to decelerate the drive wheels 93, and therefore, is shown on a negative side in FIG. 9(g).

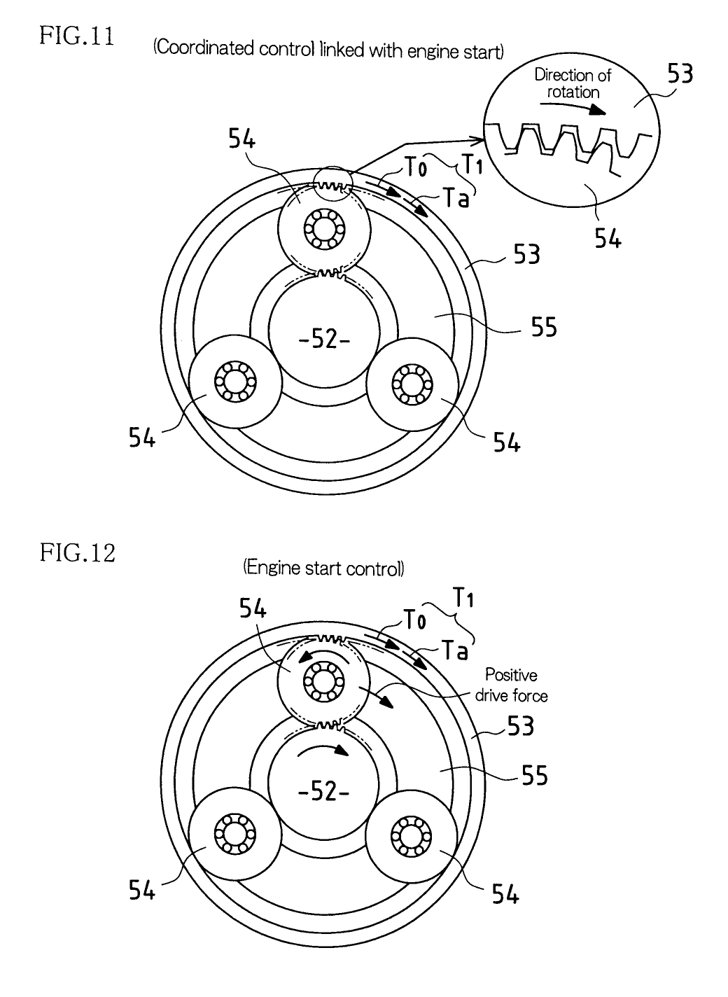

It should be noted that, as the engine 1 is stopped before the coordinated control and the crankshaft 11 and the carrier 55 are not rotating, the pinion gears 54 is not orbiting and is capable of rotating freely. Therefore, when the ring gear 53 is driven by the second motor-generator 6 with the actual target drive force T₁=T₀+Ta as shown by arrows of FIG. 11 pursuant to the coordinated control, as shown enlarged in FIG. 11 and with the rotation direction of the ring gear 53 as standard, a front surface of an inner tooth of the ring gear 53 with respect to the direction of rotation is in contact with a back surface of an outer tooth of a pinion gear 54 with respect to the direction of rotation, and backlash is eliminated. Such backlash elimination also takes place between the pinion gears 54 and the sun gear 52.

Furthermore, in order to make the backlash elimination gentler, a step-up process is performed at an initial starting stage of the coordinated control in this embodiment.

Specifically, the step-up process comprises gradual increasing of a change in the drive force of the second motor-generator 6 and a change in the braking force of the brake 20 from time t1 to time t2 as shown in FIGS. 9(f) and 9(g). As a result of execution of the step-up process, execution of the engine start control is started at time t2.

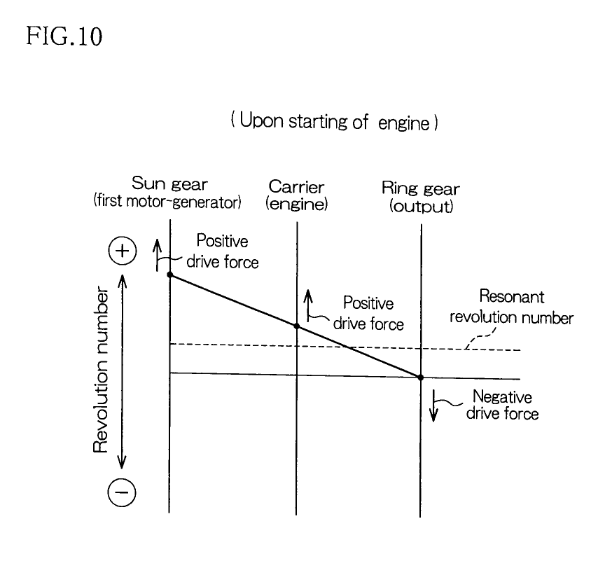

As shown in the collinear view of FIG. 10, in the engine start control, the first motor-generator 4 is operated as an electric motor to drive, as shown in FIG. 9(e) and FIG. 12, the sun gear 52 of the power distribution mechanism 5 in an appropriate direction (i.e., a clockwise direction in the figure), and therefore, a positive drive force in a positive direction (i.e., a clockwise direction in the figure) is input into the crankshaft 11 of the engine 1 via the pinion gears 54 and the carrier 55. As a result, cranking of the engine 1 is performed. The engine 1 is started by also supplying fuel and performing ignition simultaneous to the cranking. Furthermore, as shown in FIG. 9(d), when the engine revolution number increases to a revolution number at which autonomic rotation is possible (for example, a revolution number corresponding to complete explosion), cranking using the first motor-generator 4 is stopped.

Although the phenomenon of reversal (i.e., backlash reversal) of the mutual meshing positions of the gears (i.e., the sun gear 52, the ring gear 53, and the pinion gears 54) of the power distribution mechanism 5 would normally occur more readily when the engine start control is performed, the reversal can be prevented by performing the coordinated control. That is to say, although the sun gear 52, the ring gear 53, the pinion gears 54, and the carrier 55 rotate as shown by arrows in FIG. 12 upon cranking, backlash of the power distribution mechanism 5 is eliminated in a specific rotation direction by executing the coordinated control in a linked manner with the engine start control during a period from before cranking until after cranking, and therefore, reversal of the position of each of the sun gear 52, the ring gear 53, and the pinion gears 54 becomes impossible and the occurrence of rattling noise can be suppressed or prevented.

When, as shown in FIG. 9(d), the engine revolution number reaches or exceeds a specific threshold at time t3 as a result of the engine start control, the engine start control is ended, or in other words, driving of the first motor-generator 4 is stopped.

Furthermore, a step-down process of the coordinated control is executed in order to maintain backlash elimination from a time (i.e., time t3) at which the engine start control is ended, and the coordinated control is ended when a time t4 is reached.

Specifically, the step-down process comprises gradual decreasing of a change in the drive force of the second motor-generator 6 and a change in the braking force of the brake 20 from time t3 to time t4 as shown in FIGS. 9(a) to 9(g).

The period K of execution of the coordinated control is set as a regeneration prohibition period in the above-explained engine start control, and therefore, if, for example, the driver performs a by-foot depression operation of the brake pedal 21 at a time tn of FIG. 9(b) within this regeneration prohibition period K, as shown by a hatched area of FIG. 9(g), a braking force corresponding to the brake depression force is added to the target braking force Tb of the brake 20 in the coordinated control.

As explained above, when start control of the engine 1 is performed during driving in the hybrid mode, the coordinated control is performed in a linked manner therewith so as to eliminate the backlash of the power distribution mechanism 5 in a specific rotation direction using the second motor-generator 6. As a result, reversal of the mutual meshing positions of the gears (i.e., the sun gear 52, the ring gear 53, and the pinion gears 54) of the power distribution mechanism 5 becomes less likely, and suppression or prevention of the occurrence of rattling noise becomes possible.

In addition, as the positive drive force Ta of the second motor-generator 6 for elimination of the backlash is cancelled using the brake 20, an increase of the vehicle speed against the will of the driver does not occur. The above-explained characteristics are beneficial in terms of improving quietness without impairing the driving performance of the hybrid vehicle.

It should be noted that, as made clear by the above explanation of operation, when the coordinated control of the second motor-generator 6 and the brake 20 is carried out upon stopping or starting of the engine 1, the E-ECU 100, and the MG-ECU 101 and ECB-ECU 103 are capable of cooperating in a mutual fashion, and therefore, the hybrid vehicle control apparatus associated with the present invention can be seen as comprising the E-ECU 100, the MG-ECU 101, and the ECB-ECU 103.

However, in a case where the E-ECU 100, the MG-ECU 101, and the ECB-ECU 103 are not individual components and are integrated to form a single general control apparatus, the general control apparatus constitutes the hybrid vehicle control apparatus associated with the present invention.

In addition, the E-ECU 100, the MG-ECU 101, the T-ECU 102, and the ECB-ECU 103 can be integrated to form a single general control apparatus in the above-explained embodiment.

It should be noted that the present invention is not limited to the above-explained embodiment, and all modifications and changes within the scope of the claims and a scope equivalent to that of the claims are within the scope thereof. Examples of other embodiments of the present invention are presented hereinafter.

(1) In the above-explained embodiment, an example of application of the present invention to a hybrid vehicle equipped with two motor-generators 4, 6 is presented. However, the present invention is not limited thereto, and application is also possible to a hybrid vehicle combining an engine with three or more motors or motor-generators.

(2) In the above-explained embodiment, an example of application of the present invention to a hybrid vehicle of the front-engine, rear-drive (FR) type is presented. However, the present invention can also be applied to any hybrid vehicle of the front-engine, front-drive (FF) type; mid-engine, rear-drive (MR) type; rear-engine, rear-drive (RR) type, or four wheel drive (4WD) type that employs a planetary-gear type power distribution mechanism.

(3) In the above-explained embodiment, an example wherein the planetary gear mechanism of the power distribution mechanism 5 is a single planetary type is presented. However, cases exist where a planetary gear mechanism of a double planetary type or other type of gear mechanism is used in the power distribution mechanism 5, but since backlash in mutual meshing sections of gears is also considered unavoidable in such types, the present invention can be applied thereto.

(4) In the above-explained embodiment, an example wherein a reduction mechanism 7 is of a two-stage gear shift type is explained. However, the present invention can be applied even in cases where a reduction mechanism 7 of a single-stage gear shift type is provided and cases where no reduction mechanism 7 is provided.

It should be noted that without departure from the gist and principal characteristics thereof, the present invention can have many other embodiments. Accordingly, the above-described embodiments are no more than mere examples and should not be interpreted in a limited manner. The scope of the present invention is set forth by the scope of the claims, and the disclosure is in no way binding. Furthermore, all modifications and changes within a scope equivalent to that of the claims are within the scope of the present invention.

What is claimed is:

1. A control apparatus for a hybrid vehicle comprising a first motor for cranking of an engine at least upon starting thereof and a planetary-gear type power distribution mechanism for output to drive wheels of a drive force generated by at least either one of the engine and a second motor, wherein:
an engine stop control applying a negative drive force generated by the first motor to the engine upon stopping thereof during driving of the vehicle and
an engine start control performing cranking by applying a positive drive force generated by the first motor to the engine upon starting thereof during driving of the vehicle are executed, and
upon execution of the engine stop control or the engine start control, a coordinated control calculating a target drive force required to be generated by the second motor based on a drive force required for driving, adding to the target drive force a positive drive force required to eliminate backlash in a specific rotation direction at a mutual meshing section of gears of the power distribution mechanism, also calculating a braking force of a vehicle brake required for cancellation in order to prevent the added positive drive force from being transmitted to the drive wheel, and operating the second motor and the vehicle brake in a coordinated manner based on the results of calculation is executed in a linked manner.

2. The control apparatus for a hybrid vehicle according to claim 1, wherein:
the first motor is disposed between the engine and the power distribution mechanism,
the second motor is disposed closer to a drive force output than the power distribution mechanism, and
the power distribution mechanism is a planetary gear mechanism of single-planetary type comprising a sun gear whereto a rotor of the first motor is connected, a carrier whereto a crankshaft of the engine is connected via an input shaft, and a ring gear whereto an output shaft is connected.

3. The control apparatus for a hybrid vehicle according to claim 1 or claim 2, wherein:
upon execution of the engine stop control or the engine start control, a presumptive judgment is made first of all regarding whether or not the coordinated control needs to be executed, in a case wherein the coordinated control is deemed necessary, the coordinated control is executed in a linked manner with the engine stop control or the engine start control, and in a case wherein the coordinated control is deemed unnecessary, the coordinated control is not executed and only the engine stop control or the engine start control is executed.

4. The control apparatus for a hybrid vehicle according to claim 1 or claim 2, wherein:
upon execution of the coordinated control, an investigation is performed to determine whether or not the vehicle brake is abnormal, in a case wherein the vehicle brake is normal, the coordinated control is executed in a linked manner with the engine stop control or the engine start control, and in a case wherein the vehicle brake is abnormal, either the engine stop control or the engine start control is prohibited and the coordinated control is prohibited.

5. The control apparatus for a hybrid vehicle according to claim 1 or claim 2, wherein:
in a case wherein, after the coordinated control has been executed and prior to execution of the engine stop control or the engine start control to be linked therewith, if execution of the other of the engine stop control or the engine start control is required, the coordinated control is ended without executing the control to be linked, and the required control is then executed.
